(19) United States
(12) Patent Application Publication
(10) Pub. No.: US 2026/0194203 A1
(43) Pub. Date: Jul. 9, 2026

(54) LIGHTING SYSTEM WITH MOISTURE MANAGEMENT

(71) Applicant: Federal Signal Corporation, Downers Grove, IL (US)

(72) Inventors: Christopher Radzik, New Lenox, IL (US); George Frank, Crown Point, IN (US); Paul M. Gergets, Saint John, IN (US)

(21) Appl. No.: 19/412,047

(22) Filed: Dec. 8, 2025

Related U.S. Application Data
(60) Provisional application No. 63/742,638, filed on Jan. 7, 2025.

(51) Int. Cl. F21S 45/10; B60Q 1/52; F21S 43/14; F21S 43/19; F21S 45/60; H05B 1/02

(52) U.S. Cl. CPC F21S 45/10; B60Q 1/52; F21S 43/14; F21S 43/195; F21S 45/60; H05B 1/0236

(57) ABSTRACT

Lighting system for a vehicle that is adapted to manage moisture within or on the exterior of the lighting system. The lighting system is thus adapted to reduce accumulation of snow, ice and condensation on the exterior and interior of the lighting system's lens. In an example the lighting system includes a printed circuit board to which is mounted both lighting elements and heat generators that are independently controllable by a controller. The lighting elements and heat generators are relatively positioned to maximize moisture management while minimizing the magnitude of power fed to the heat generators.

### RELATED APPLICATION

This patent application is related to U.S. Pat. No. 8,636,395, the content of which is hereby incorporated by reference in its entirety.

### BACKGROUND

Vehicles are commonly equipped with signal lights. Brake lights, for example, when illuminated, indicate that brakes have been applied in the vehicle. Turn signal lights, when flashing, indicate that a vehicle may be intending to make a left or a right turn. Reverse lights, when illuminated, indicate that a vehicle is in reverse gear. Specialty vehicles, such as commercial vehicles, emergency vehicles, tow trucks, construction, and maintenance vehicles commonly include additional signal lights such as warning lights. In some vehicles, multiple warning lights are positioned in a lightbar that is affixed to a vehicle, and the warning lights of the lightbar are configured to illuminate or flash in a coordinated manner.

Vehicular warning light lightbars have in recent years evolved from the use of incandescent bulbs to generate light to light emitting diodes (LEDs). Among other improvements, LEDs are more efficient at converting electrical power to light output.

### SUMMARY

In general terms, the present disclosure is directed to a lighting system for a vehicle configured to control a light emitting component and an associated heat generating component.

In further general terms, the present disclosure is directed to a lightbar having a light emitting component and an associated heat generating component.

In further general terms, the present disclosure is directed to a vehicle to which is mounted a lighting system or lightbar having a controllable light emitting component and an associated controllable heat generating component.

According to one aspect, a lighting system includes a lighting device, the lighting device including: a housing defining an interior volume of the housing; and a printed circuit board (PCB) positioned within the interior volume of the housing, the PCB including a substrate, a light emitter mounted to the substrate, and a heat generator configured differently from the light emitter and also mounted to the substrate; and at least one controller operatively coupled to the light emitter and to the heat generator via the substrate, the at least one controller being configured to control light emission by the light emitter and heat generation by the heat generator.

According to another aspect, a lightbar for a vehicle includes: a housing defining an interior volume of the housing; a printed circuit board (PCB) positioned in the interior volume of the housing, the PCB including a substrate, light emitters mounted to the substrate, and heat generators configured differently from the light emitters and also mounted to the substrate; and a controller operatively coupled to the light emitters and to the heat generators via the substrate, the controller being configured to control light emission by the light emitters and heat generation by the heat generators, wherein the heat generators are positioned closer than the light emitters to an outer edge of a major surface of the PCB.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 schematically depicts a vehicle, the vehicle including an example lighting system according to the present disclosure.

FIG. 2 schematically depicts example components of the lighting system of FIG. 1.

FIG. 3 schematically depicts example components of the controller of the lighting system of FIG. 1.

FIG. 4 is a planar view of an example of the lightbar of the lighting system of FIG. 1.

FIG. 5 is perspective view of a portion of the lightbar of FIG. 4.

FIG. 6 is a further perspective view of the portion of the lightbar of FIG. 5.

FIG. 7 depicts example components of the lightbar of FIG. 4.

FIG. 8 is a perspective view of an example of the printed circuit board (PCB) of the lighting system of FIG. 1.

FIG. 9 depicts a planar view of a portion of the PCB of FIG. 8, the portion being called out in FIG. 8.

FIG. 10 is a circuit diagram of a portion of the circuitry of the lighting system of FIG. 1.

FIG. 11 is a perspective view of a further example of a PCB that can be used with the lighting system of FIG. 1, including a schematically depicted component.

FIG. 12 is a planar view of a portion of another lightbar that can be used with lighting system of FIG. 1.

FIG. 13 is a top end planar view of the lightbar that includes the lightbar portion of FIG. 12.

FIG. 14 is front end planar view of the lightbar of FIG. 13.

FIG. 15 is a cross-sectional view of a portion of the lightbar of FIG. 13, along the line 15-15 in FIG. 13.

### DETAILED DESCRIPTION

The present disclosure is directed towards lighting systems, lightbars, vehicles with lightbars and lighting systems, and associated methods. Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

The light generating devices of vehicular warning lightbars have largely evolved from incandescent bulbs to light emitting diodes (LEDs). Among other improvements, LEDs are more efficient at converting electrical power to light output. However, an unintended consequence of this improved efficiency is the lightbar's poor ability to shed snow and ice from the exterior and interior of the lightbar's lens in cold weather, and to evaporate condensation that may develop on the interior and/or exterior surface of the lightbar's lens.

Heating the lens of the lightbar can draw too much electrical current causing excessive strain or overload on the vehicle's battery, particularly when the vehicle's battery has low charge and/or when the light emitters of the lightbar are also drawing electrical current from the same battery or other power supply. Aspects of the present disclosure relate to optimization of lighting and heating elements of a lightbar. The optimization is achieved, in part, by mounting both the light emitters and the heat generators on the same printed circuit board (PCB). This facilitates one or more controllers that are operatively connected to the PCB to easily and effectively control power to, for instance, the heat generators, based on an operational status of the light emitters. In addition, mounting the heat generators directly to the PCB allows optimization of placement of the heat generators close to the lens, but not close enough to damage the lens. In addition, mounting the heat generators directly to the PCB allows multiple relatively small heat generators to be distributed around the perimeter of the lightbar so that the heat generated is well distributed about the lightbar rather than concentrated in one area, the latter of which could cause damage to delicate electronics or other components of the lightbar due to excessive localized temperatures. Other advantages and optimization capabilities of the lighting systems of the present disclosure will be borne out herein.

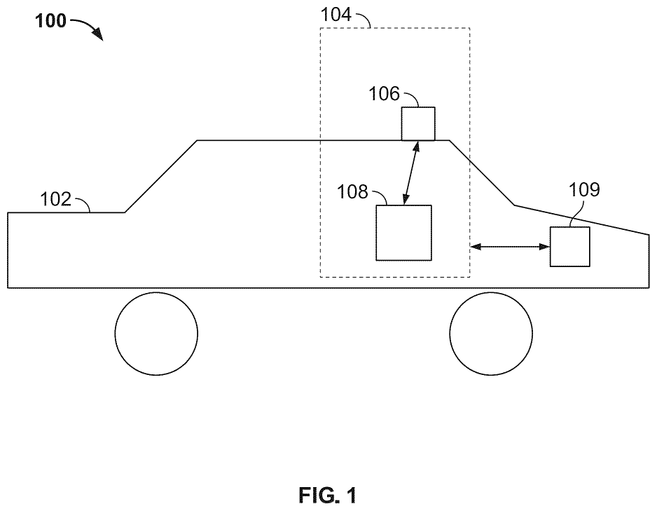

FIG. 1 schematically depicts a vehicle 100, the vehicle including an example lighting system according to the present disclosure.

The vehicle 100 can be any vehicle for which a lightbar 106 is suitable. For example, the vehicle 100 can be a police vehicle, a fire engine, an ambulance, another type of emergency vehicle, a patrol vehicle, a tow truck, a construction vehicle, a utility truck, and the like.

The vehicle 100 includes a vehicle body 102. The body 102 supports a lighting system 104 according to the present disclosure, as well as one or more vehicle operation components 109.

Components of the system 104 can be distributed across different parts of the body 102 vehicle. For example, a portion of the system 104 can be positioned within a cabin of the vehicle 100, while another portion of the system 104 can be positioned on an exterior surface of the body 102.

The system 104 includes a lightbar 106, or other lighting device consistent with the principles of the present disclosure, mounted to an exterior surface of the body 102 of the vehicle 100.

The system 104 also includes a user interface 108. For instance, the user interface 108 can include one or more hard buttons, hard switches, and/or a touch screen interface positioned within the cabin of the vehicle 100. The interface 108 allows for control of the lightbar 106 via inputs to the interface 108. The interface 108 also provides status information about the lightbar 106, e.g., indicia indicating an operating status of the lightbar 106, the pre-programmed flashing pattern being emitted by the lightbar 106, the ambient temperature at or near the lightbar 106, and the operating status of one or more heat generators of the lightbar 106.

The system 104 is in operative communication with the one or more vehicle operation components 109. The operative communications can be achieved through a hard wired or fully or partially wireless connection (e.g., over a network). The vehicle operation components 109 can include, for example, a battery that supplies power to electrical components of the vehicle 100, including the lightbar 106. The vehicle operation components 109 can also include one or more computing devices that can supply data about the operational status of the lightbar 106 and individual components of the lightbar 106 (such as whether and how many, or which ones of the light emitters of the lightbar 106 are on versus off). The data can also indicate, for instance, whether the motor of the vehicle is running or off, whether the transmission is idle or engaged, and the level of charge of the vehicle's battery.

The lighting system 104 is configured to control components of the lightbar 106 based, in part, on data inputs received from the vehicle operation components 109.

It will be appreciated that the depicted lighting system 104 includes a lightbar 106. A lightbar is just one of many example lighting devices to which the principles of the present disclosure can be readily applied.

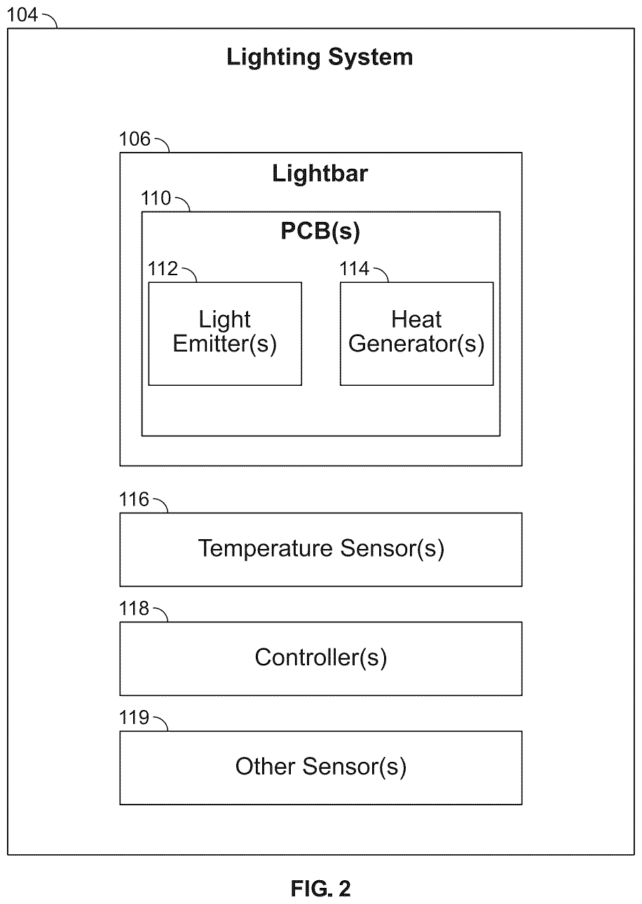

FIG. 2 schematically depicts further example components of the lighting system 104 of FIG. 1.

Referring to FIG. 2, the lighting system 104 includes the lightbar 106, one or more temperature sensors 116, and one or more controllers 118.

The lightbar 106 includes one or more PCBs 110. Mounted to each of the one or more PCBs are one or more light emitters 112 and one or more heat generators 114.

The controller 118 is configured to generate electronic control signals to control the light emitter(s) 112 and the heat generator(s) 114 via the PCB(s) 110.

The temperature sensor(s) 116 is/are configured to sense a temperature (e.g., an ambient temperature) internal to the lightbar 106 and/or external to the lightbar 106. In some examples, a temperature sensor 116 is mounted within a housing of the lightbar 106. In some examples, a temperature sensor 116 is mounted to an exterior surface of a housing of the lightbar 106. In some examples, a temperature sensor 116 is mounted to an exterior surface of a housing of the lightbar 106 and another temperature sensor 116 is mounted within the housing of the lightbar. In some examples the temperature sensor 116 is otherwise supported by the body 102 of the vehicle 100 (FIG. 1) to detect a temperature at or near the lightbar 106.

The temperature senor(s) 116 can include, for example, one or more thermometers and/or one or more thermocouples or other temperature sensitive hardware.

The temperature sensed by the temperature sensor(s) 116 can be read by the controller(s) 118 as data inputs to the controller(s) 118 that the controller(s) 118 is/are configured to use to control operation of the light emitters 112 and the heat generators 114.

In some examples, the lighting system 104 can include one or more other sensors 119. The one or more other sensors 119 are configured to collect additional data that is fed to the controller(s) 118 and used by the controller(s) 118 to control operation of the light emitters 112 and the heat generators 114. For instance, the one or more other sensor(s) 119 can include one or more humidity sensors placed within the housing of the lightbar 106 and/or exterior to the lightbar 106. The humidity sensor(s) are configured to sense a relative humidity of the air. Temperature and relative humidity readings by the sensors 116 and 119 can be used by the controller(s) 118 to determine of condensation on an interior surface and/or exterior surface of a lens of the lightbar 106 is likely and, if so, to cause the heat generators 114 to power on to reduce or eliminate such condensation.

The one or more other sensors 119 can include a sensor configured to measure another characteristic of the environment around the vehicle 100 or the lightbar 106 that can be used by the controller(s) 118 to determine whether to what extent to power the heat generators 114, such as a light sensor that detects ambient light, an accelerometer or the like that detects vibration (e.g., vibration that could lead to natural shedding of snow and ice from the lightbar), and others.

The light emitter(s) 112 is/are configured differently from the heat generator(s) 114.

Each light emitter 112 can be any suitable electrical or electronic component configured to generate light. In some examples, each light emitter 112 is a light emitting diode (LED) that emits light when electrical current is supplied to the light emitter 112.

Each heat generator 114 can be any suitable electrical or electronic component configured to generate heat. In some examples, each heat generator 114 is an electrical resistor. The electrical resistor can be a variable resistor or a non-variable resistor. In some examples, the electrical resistor can be rated in a range between 1 Watt and 5 Watts inclusive, or in range between 2 Watts and 4 Watts inclusive. In some examples, each electrical resistor is rated at 3 Watts. By rated is meant the maximum power output of the resistor when electrical current is being supplied to the resistor.

In some examples, different ones of the resistors are configured to output different magnitudes of power, e.g., depending on their placement on a PCB relative to a particular side or edge of a lightbar. In some examples, all of the resistors are configured to output the same magnitude of power.

At least a majority of the power output of each heat generator 114 is in the form of heat, including infrared radiation. At least a majority of the power output of each light emitter 112 is, at least in some examples, in the form of visible light. In some examples, at least 80 percent of the power output of each heat generator 114 is heat and at least 80 percent of the power output of each light emitter 112 is visible light.

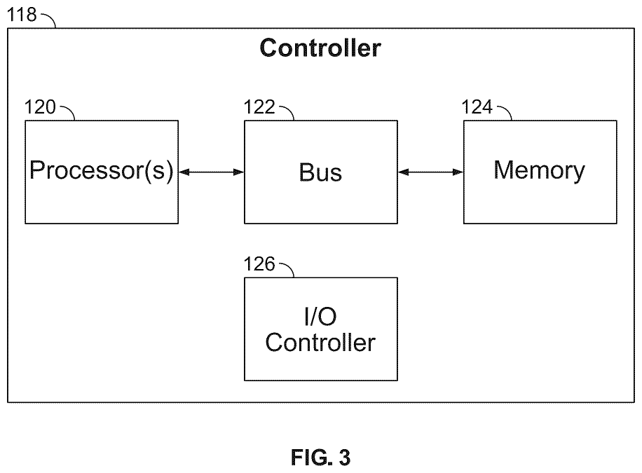

FIG. 3 schematically depicts example components of the controller 118 of the lighting system 104 of FIG. 1.

Referring to FIG. 3, the controller 118 is configured to control one or more PCBs of one or more lightbars of a vehicle.

The controller 118 includes one or more processors 120, a system bus 122, a memory 124 and an input/output (I/O) controller 126.

The bus 122 couples the memory 124 to the processor(120).

The memory 124 includes a random access memory (“RAM”) and a read-only memory (“ROM”). The memory 124 can also include a mass storage device. The mass storage device is non-transitory computer readable storage that can store software instructions and data used to generate signals that are output to the lightbar(s) and the user interface. For example, the memory 124 can store instructions that generate different light flashing patterns of the lightbar 106 depending on an input provided by the user interface 108. As another example, the memory 124 can store instructions that dictate when the heat generators 114 are powered on or off, and as well as allocation of electrical current that is supplied to the heat generators 114 and the light emitters 112 in different scenarios (e.g., based on different input parameters, such as temperature, humidity, whether the vehicle engine is running, whether the light emitters 112 are on, and the like).

The controller 18 is operatively connected (e.g., via wired and/or wireless network connections) to one or more lightbars, the user interface, the temperature sensor(s), and the vehicle operation components of a vehicle.

The mass storage device of the memory 124 and its associated computer-readable data storage media provide non-volatile, non-transitory storage for the controller 118. In some examples, the mass storage device is a component of the lighting system 104 that is physically remote from the controller 118 but is nevertheless operatively connected to the controller 118 such that the processor(s) 120 can process the data and instructions stored thereon. In other examples, the mass storage device is integrated with the controller 118.

Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central processing unit can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the computing devices.

The I/O controller 126 is configured to receive and process input from other devices, such as the user interface 108, the vehicle operation components 109, the temperature sensor(s) 116, and the other sensor(s) 119. The I/O controller is also configured to provide output in the form of electronic control signals to user interface 108 and the PCB(s) 110 of the lightbar 106.

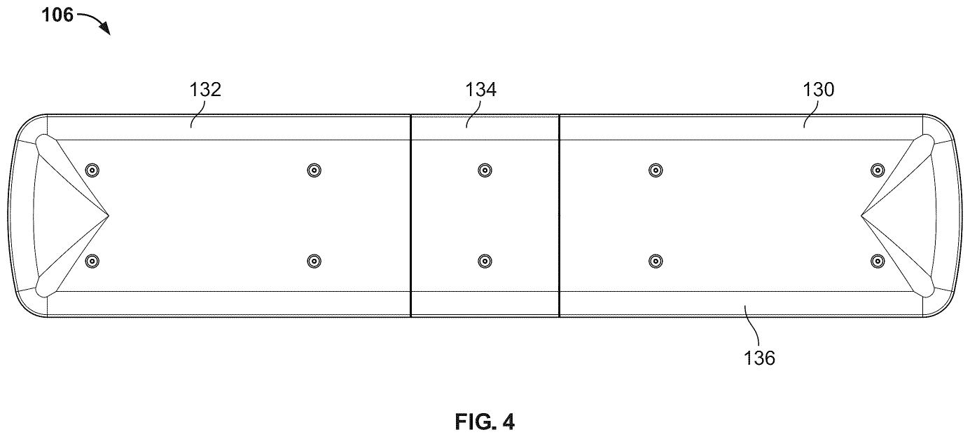

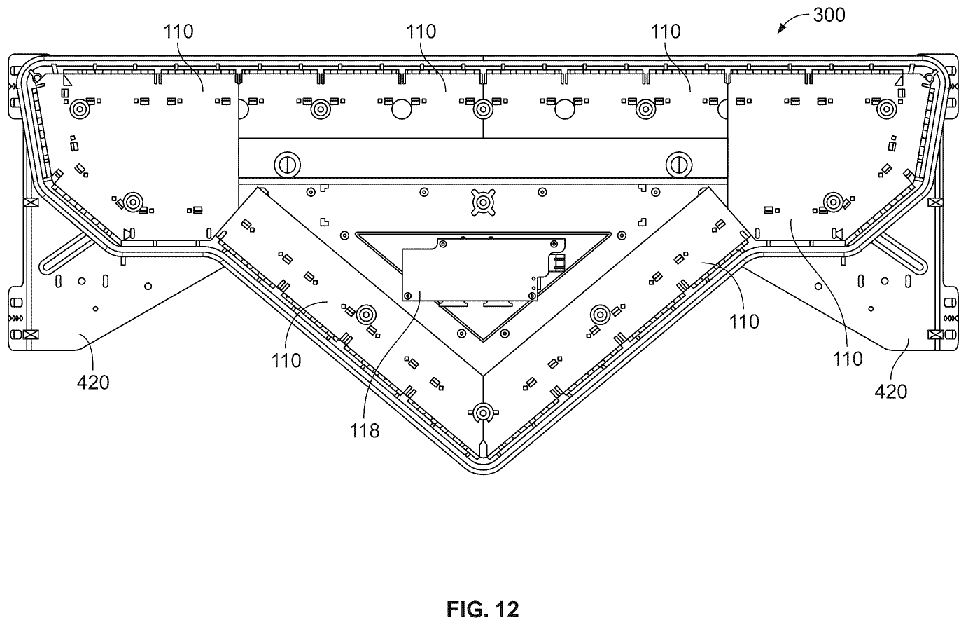

FIG. 4 is a planar view of an example of the lightbar 106 of the lighting system of FIG. 1. The lightbar 106 of FIG. 1 can have different configurations from the configuration shown in FIG. 4. Another, non-limiting, example configuration of a lightbar 300 that can be substituted for the lightbar 106 in the lighting system 104 is shown in FIG. 12.

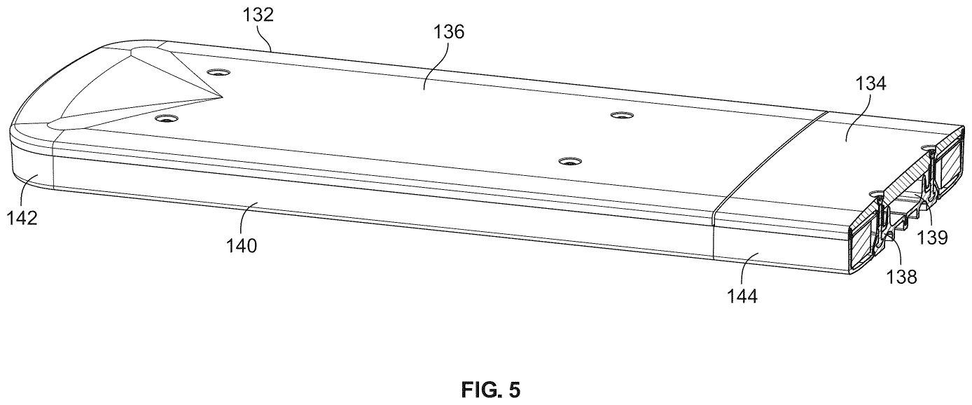

FIG. 5 is perspective view of a portion of the lightbar 106 of FIG. 4.

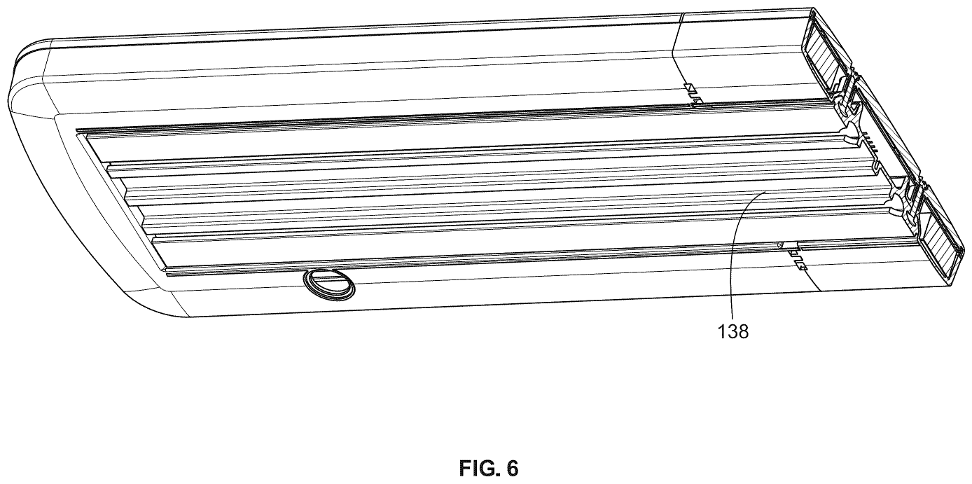

FIG. 6 is a further perspective view of the portion of the lightbar 106 of FIG. 5.

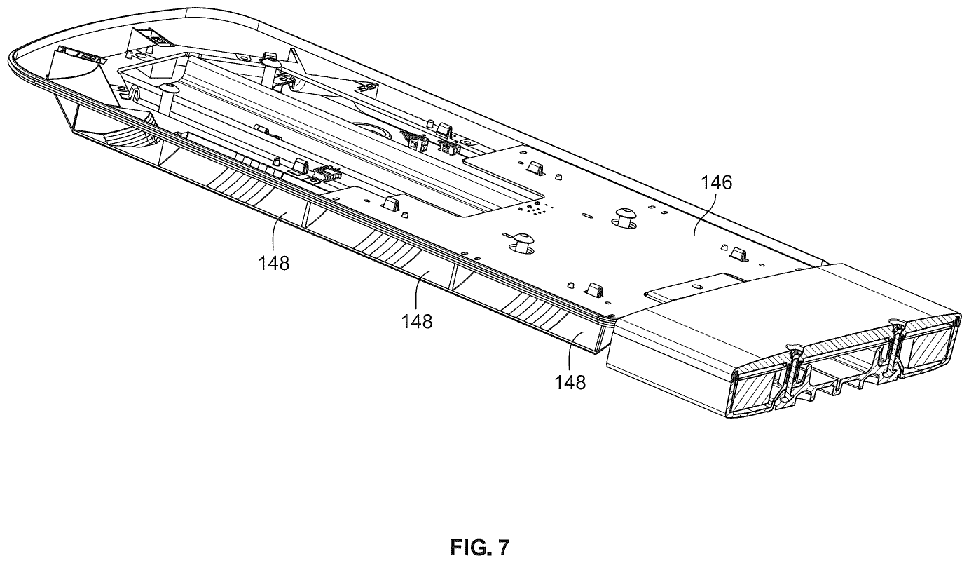

FIG. 7 depicts example components of the lightbar 106 of FIG. 4.

Referring to FIGS. 4-7, in this example, the lightbar 106 is constructed of three modules 130, 132, and 134 that are removably fastened together. Two end modules 130 and 132 are connected to opposite sides of a central module 134. The lightbar 106 can be increased or decreased in size by adding or removing additional modules.

Each module 130, 132, 134 can include a dedicated printed circuit board (PCB) to which are mounted light emitters and heat generators. A central controller, stored in the lightbar 106, or externally thereto, e.g., in another portion of the vehicle, generates control signals that can independently activate the light emitters of the different modules 130, 132, 134 as well as the heat generators.

The lightbar 106 can house its own dedicated power supply to generate the electricity needed to operate the lightbar, and/or receive power from another power source on the vehicle, such as the vehicle's battery. A power cord from the battery can be plugged into the lightbar 106 to provide electrical current to the lightbar 106.

The lightbar 106 includes a housing that houses various components. In this example, the housing includes a top housing piece 136 and a bottom housing piece 138 that are mated to each other and define an interior volume of the lightbar 106 in which various electrical and optical components are positioned and mounted. The bottom housing piece 138 is configured to mount the lightbar 106 to an exterior surface of a vehicle.

The top housing piece 136 can be a dome. When the lightbar 106 is mounted to a vehicle, the top housing piece 136 is positioned to be exposed to sunlight. In some examples, the top housing piece 136 is constructed of metal and an exterior surface of the metal is coated with a material configured to absorb radiant energy from the sun. In this manner, the top cover 136 can be configured as a heat sink that warms, e.g., the lenses of the lightbar 106 to help prevent or melt snow and ice and/or prevent or evaporate condensation therefrom. The coating can include, for example, a material with a dark (e.g., black) color, such as black paint. The coating can include one or more compositions configured to absorb radiant energy in the form of heat.

The lightbar 106 includes lenses (such as lenses 140, 142, 144) arranged around a portion or around the entire perimeter of the lightbar. The lenses are at least partially transparent and are configured to focus and/or otherwise transmit light beams emitted from lighting units positioned within the housing of the lightbar 106, with each of the lighting units including a portion of a PCB having light emitters (e.g., LEDs) and heat generators mounted thereto. The lenses are attached to one or both of the housing pieces 136 and 138.

The housing of the lightbar 106 includes discrete lighting units 148 positioned around a portion or the entirety of the perimeter of the lightbar 106. The lighting units 148 are powered and controlled by one or more PCBs (e.g., the PCB 146, which can correspond to a PCB 110) to generate light beams that propagate through the corresponding lens associated with a given lighting unit. The discrete lighting units can be controlled independently of one another by one or more controllers, e.g., by a central controller 118, allowing a large variety of flashing patterns, warning signals, and combinations to be generated by the lightbar 106.

Each lighting unit includes one or more light emitters configured to emit light according to control signals generated by the controller 118 and delivered via the corresponding PCB 110, 146.

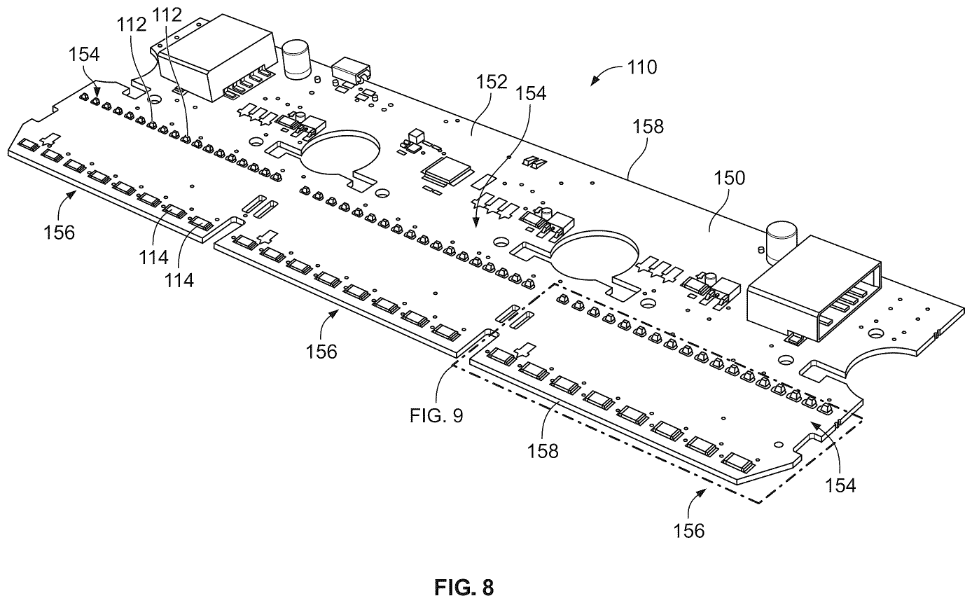

FIG. 8 is a perspective view of an example of the printed circuit board (PCB) 110 of the lighting system 104 of FIG. 1.

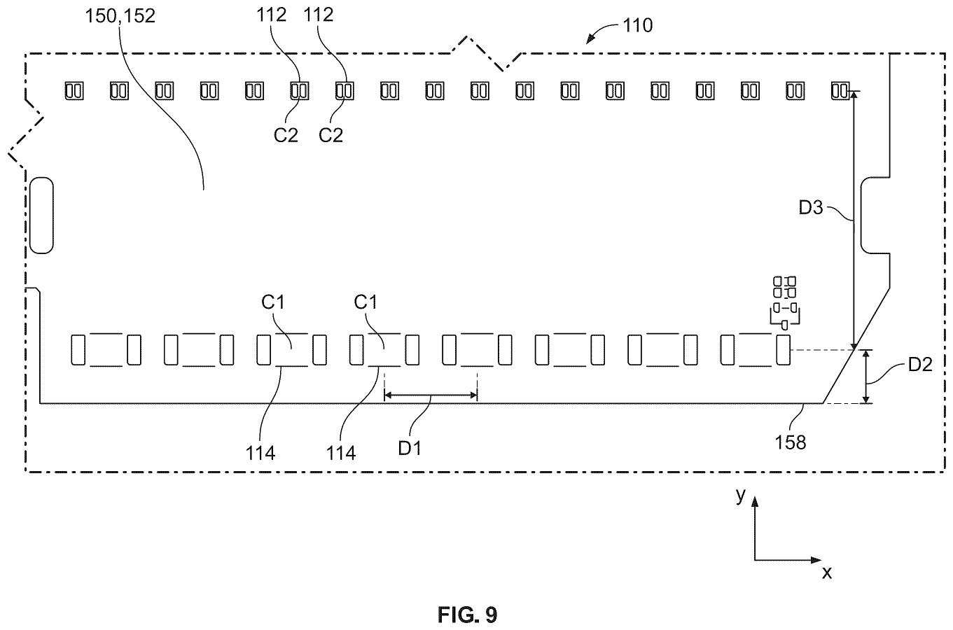

FIG. 9 depicts a planar view of a portion of the PCB of FIG. 8, the portion being called out in FIG. 8 and labeled in FIG. 8 as FIG. 9.

Referring to FIGS. 8-9, the PCB 110 can be mounted in interior volume of the housing of a lightbar, such as the lightbar 106 of FIG. 4.

The PCB 110 includes a substrate 150 that supports a variety of electrical and electronic components. Electrical pathways between components can be printed on and/or embedded within the substrate 150.

The substrate 150 has a major surface 152 having an outer perimeter that is defined by an outer edge 158 of the substrate 150.

Mounted to the major surface 152 are one or more banks 154 of light emitters 112, and one or more banks 156 of heat generators 114. In this particular example, the PCB 110 includes three light emitter banks 154, each bank 154 with 18 light emitters 112 arranged in a single row. For each light emitter bank 154, the PCB 110 includes a corresponding heat generator bank 156. In this example, each heat generator bank includes eight heat generators 114 arrange in a single row. The rows of heat generator banks are parallel to the rows of light emitter banks.

In some examples, each corresponding pair of a light emitter bank 154 and a heat generator bank 156 can be controlled (e.g., powered on and off) independently of the other such pairs by the controller(s) 118. For example, one light emitter bank 154 can be powered together with its heat generator bank 156, while another light emitter bank 154 can be powered off, with its heat generator bank 156 either powered on or powered off.

FIG. 9 defines an x-y plane for a portion of the PCB 110 that includes one of the light emitter banks 154 and a corresponding one of the heat generator banks 156.

The heat generators 114 are positioned closer to the edge 158 than the light emitters 112.

The positioning of the light emitters 112 and the heat generators 114 on the major surface 152 of the substrate 150 is configured to optimize power allocation to the light emitters 112 and the heat generators 114 to minimize overloading of the power source (e.g., the vehicle battery) regardless of the operating state of the vehicle and the lightbar 106, while effectively removing or preventing snow, ice, and/or condensation buildup within the lightbar 106 or on an exterior surface of the lightbar 106.

For example, centers C1 of adjacent heat generators 114 in the heat generator bank 156 are a distance D1 apart parallel to the x-axis. The distance between the center C1 of each heat generator 114 and the nearest portion of the outer edge 158 (i.e., in a direction away from the light emitters 112) along the y-axis is a distance D2. The distance between the center line that passes through the centers C1 of the heat generators 114 and the center line that passes through the centers C2 of the light emitters 112 parallel to the y axis is a distance D3. These center lines are parallel to each other.

To optimize the power consumption and heating characteristics described herein, the distance D1 is in a range from 0.25 inches to 0.75 inches, inclusive. In some examples, the distance D1 is in a range from 0.40 inches to 0.50 inches, inclusive. In some examples, the distance D1 is 0.4 inches.

In addition, the distance D2 is less than 0.50 inches. In some examples, the distance D2 is less than 0.30 inches. In some examples, the distance D2 is less than 0.25 inches. In some examples, the distance D2 is 0.23 inches. The distance D2 is selected such that the heat generators are close enough to the lens to prevent and/or remove snow, ice and/or condensation buildup while drawing minimal magnitude of electrical current.

In addition, the distance D3 is in a range from 1.00 inches to 2.00 inches, inclusive. In some examples, the distance D3 is in a range from 1.25 inches to 1.50 inches, inclusive. In some examples, the distance D3 is 1.35 inches. The distance D3 can be selected to avoid damage to the light emitters 112 by heat generated by the heat generators 114.

In some examples, the distance D1 is in a range from 0.40 inches to 0.50 inches, inclusive, the distance D2 is less than 0.3 inches, and the distance D3 is in range from 1.25 inches to 1.50 inches, inclusive.

In one example, the distance D1 is 0.40 inches, the distance D2 is 0.23 inches, and the distance D3 is 1.35 inches.

Other dimensions outside of these values and ranges are possible.

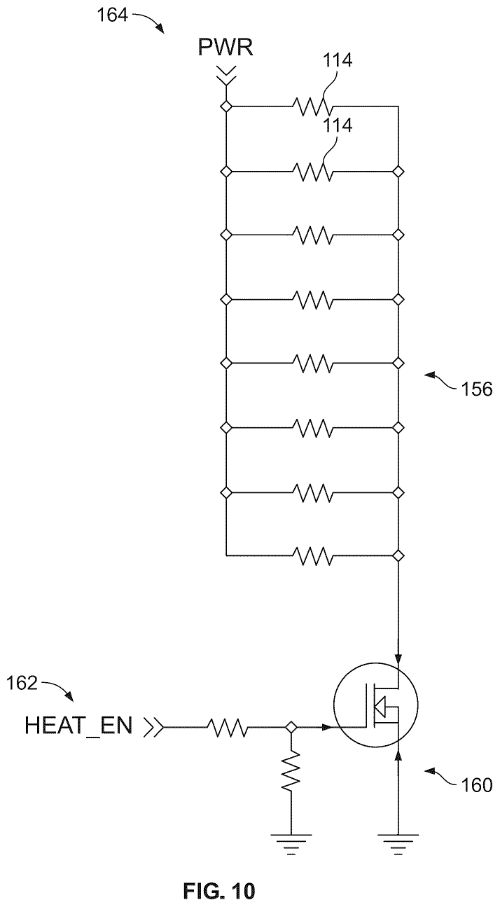

FIG. 10 is a circuit diagram of a portion of the circuitry of the lighting system of FIG. 1. FIG. 10 depicts one bank 156 of eight heat generators 114, which are electrical resistors connected in parallel. At the high voltage end of the bank 156 is the power source 164 (e.g., the vehicle battery) that supplies electrical current to the resistors 114. At the low voltage end of the bank 156 is a grounded switch 160. The switch 160 is controlled by control signal 162 output by the controller 118. The control signals manipulate the switch 160 between at least three different configurations - one configuration in which electrical current to the bank 156 is shut off, another configuration in which electrical current to the bank 156 is turned on at a maximum magnitude, and another configuration in which electrical current to the bank 156 is turned on but stepped down by some magnitude from the maximum magnitude due to one or more other conditions of the vehicle or the lightbar.

Non-limiting example scenarios of the configurations of the switch 160 and when they are implemented will now be described.

In some examples, the controller 118 is configured to adjust power to the heat generator(s) based on one or more variables including but not limited to: an ambient temperature, a level of charge of a battery of the vehicle, whether electrical current is being supplied to the light emitter, how many and/or which ones of a lightbar's plurality of lighting units are operating, whether an engine of the vehicle is running, and others. These variables or conditions of the vehicle and lightbar are transmitted as status data to the controller 118 and based on that data the controller 118 determines how to operate the heat generators 114 and light emitters 112 of the lightbar.

In a first example instance, the controller 118 is configured to cause the power source, via the switch 160, to supply a first magnitude of electrical current to the heat generator(s) when an ambient temperature (e.g., a temperature at an exterior of the lightbar 106) is sensed to be at or below a threshold temperature (e.g., 35 degrees Fahrenheit) a non-zero electrical current is being supplied to the light emitter(s).

In a second example instance, the controller 118 is configured to cause the power source, via the switch 160, to supply a second magnitude of electrical current to the heat generator(s) when the ambient temperature is sensed or otherwise measured to be at or below the threshold temperature (e.g., 35 degrees Fahrenheit) and zero electrical current is being supplied to the light emitters. Between the first example instance and the second example instance the second magnitude of electrical current is greater than the first magnitude of electrical current. In this manner, the system 104 is configured to avoid overloading the power source by avoiding supplying too much power to the heat generators when the light emitters are also activated.

Still referring to the first instance and the second instance, in some examples, the first total magnitude of electrical current supplied to the heat generators and the light emitters in the first instance is equal or approximately equal to a second total magnitude of electrical current supplied to the heat generator and the light emitter in the second instance. In some examples, the first total magnitude and the second total magnitude can be in a range from 10 Amperes to 40 Amperes, inclusive, or from 20 Amperes to 25 Amperes, inclusive. In some examples, the first total magnitude and the second total magnitude can each be about 23 Amperes.

If the charge of the battery is below a minimum threshold, the first total magnitude and second total magnitude can be reduced by some amount.

If the engine of the vehicle is not running, the first total magnitude and second total magnitude can likewise by reduced by some amount or another amount.

In a third example instance, if the ambient temperatures is sensed or otherwise measured to be above the threshold temperature, then the controller 118 is configured, via the switch, to cause zero electrical current to be supplied to the heat generators 114 regardless of other conditions of the vehicle and/or lightbar 106.

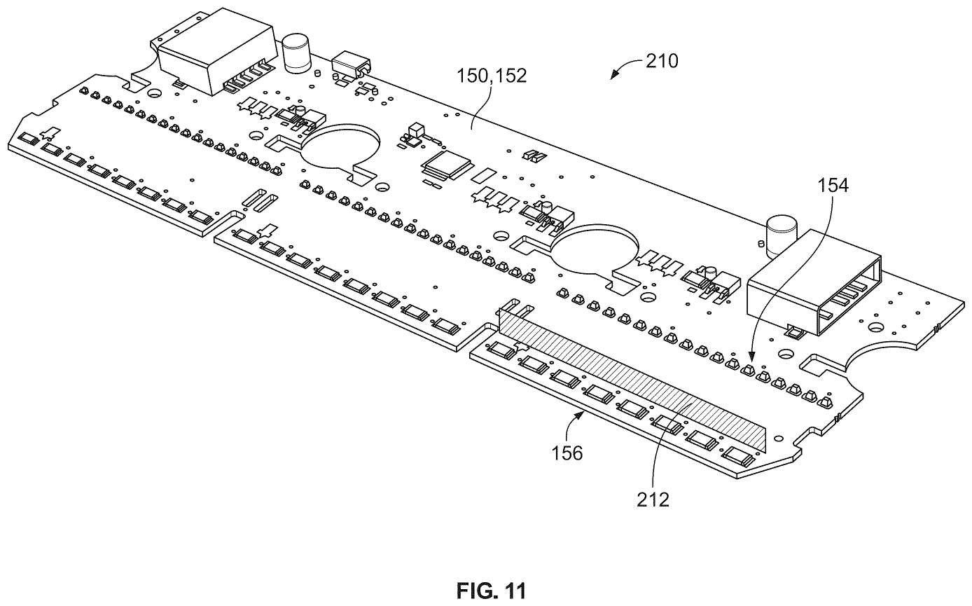

FIG. 11 is a perspective view of a further example of a PCB 210 that can be used with the lighting system of FIG. 1, including a schematically depicted component. That is, the PCB 210 is interchangeable with the PCB 110.

The PCB 210 is configured the same as the PCB 110 except that the PCB 210 includes a wall 212 projecting from the major surface 152 of the substrate 150 of the of the PCB 210. For example, the wall 212 can project from the major surface 152 perpendicularly to the plane formed by the x-and y-axes of FIG. 9.

The wall 212 is positioned (relative to the y-axis) between a bank 154 of light emitters and the corresponding bank 156 of heat generators. In the example depicted, the wall 212 is positioned closer to the bank 156 of heat generators than to the bank 154 of light emitters.

The wall 212 can have a maximum height measured perpendicularly to the x-y plane that is the same height, slightly lower, or slightly greater than a corresponding maximum height of the heat generators. The height of the wall 212 is not necessarily drawn to scale in FIG. 11. The height of the wall 212 can be configured so as not to distort or interfere with the light propagation from the bank 154 of light emitters.

In the example shown, the wall 212 spans an entire dimension of the bank 156 of heat generators parallel to the x-axis. In other examples, multiple such walls can be included for a single bank of heat generators, with gaps in between the walls parallel to the x-axis.

The wall 212 is configured to redirect or reflect infrared radiation generated by the bank 156 of heat generators toward the lens of the lightbar, thereby increasing the amount of generated heat at the lens and decreasing the amount of heat at other portions of the PCB 210, such as the bank 154 of light emitters. That is, the wall 212 can serve to improve the efficiency of the lightbar's ability to prevent, reduce, or minimize ice, snow, and/or condensation build up.

The wall 212 can be constructed of one or more materials, and/or be coated with one or more materials configured to be good reflectors of infrared radiation. In some examples, the wall 212 is a hot mirror, e.g., constructed of glass with a thin film coating of reflective material, such as aluminum or silver.

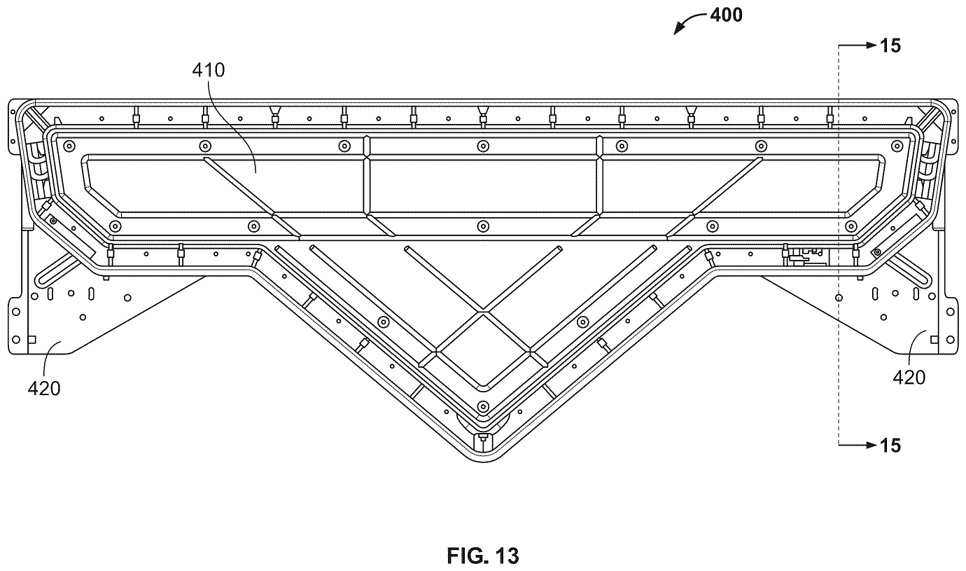

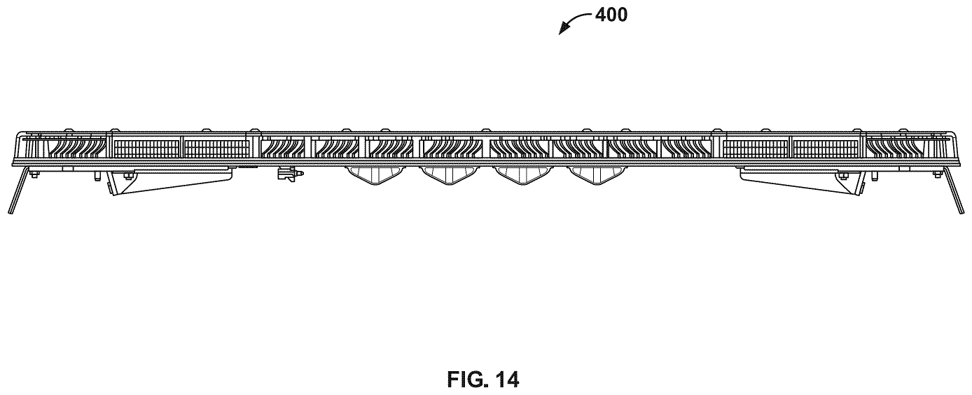

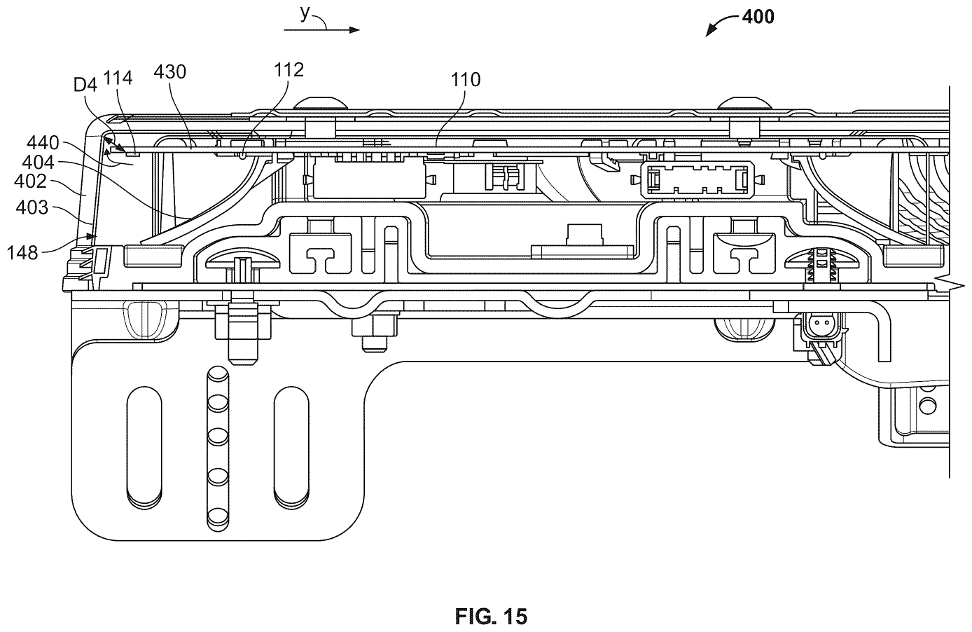

FIG. 12 is a planar view of a portion 300 of another lightbar 400 (FIGS. 13-15) that can be used with lighting system of FIG. 1. FIG. 13 is a top end planar view of the lightbar 400. FIG. 14 is front end planar view of the lightbar 400. FIG. 15 is a cross-sectional view of a portion of the lightbar 400 of FIG. 13, along the line 15-15 in FIG. 13.

Referring to FIGS. 12-15, the lightbar 400 has six different PCBs 110 of different shapes and sizes forming the shape of the lightbar (as seen from above) shown in FIGS. 12 and 13. Each of the PCBs 110 can include banks of light emitters and corresponding banks of heat generators as described herein. A common controller 118 can be configured to control light emission and heat generation by each of the PCB's 110 of the lightbar 400.

The lightbar 400 is configured to be mounted to a vehicle with fasteners extending through mounting flanges 420 of the lightbar 400.

The top housing piece 410 of the lightbar 400 is positioned to be exposed to sunlight when the lightbar 400 is mounted to a vehicle. In some examples, the top housing piece 400 is constructed of metal and an exterior surface of the metal is coated with a material configured to absorb radiant energy from the sun. In this manner, the top cover 400 can be configured as a heat sink that warms, e.g., the lenses of the lightbar 400, including the lens 402, to help prevent or melt snow and ice and/or prevent or evaporate condensation therefrom. The coating can include, for example, a material with a dark (e.g., black) color, such as black paint. The coating can include one or more compositions configured to absorb radiant energy in the form of heat.

The lightbar 400 includes multiple lighting units 148 positioned around the perimeter of the lightbar 400. Each lighting unit 148 includes a reflector 404 to concentrate and collimate the light beam generated by the lighting unit 148 through the corresponding lens 402. Extending into at least some of the lighting units 148 are portions, such as the portion 430, of a PCB 110. Each portion 430 of a PCB 110 includes one or more light emitters 112 and one or more heat generators 114 that are dedicated to single lighting unit 148. For a given lighting unit 148, the positioning of a light emitter 112 and a heat generator 114 relative to each and relative to the reflector 404 is shown in FIG. 15.

The distance between the heat generator 114 and the light emitter 112 shown in FIG. 15 is as described above in connection with FIG. 9 (distance D3). The shortest distance between a center of the heat generator 114 and the interior surface 403 of the lens is as described above in connection with FIG. 9 (distance D2). In addition, the heat generator 114 is in close proximity to a top-most edge of the interior surface 403 of the lens 402. In this example, the heat generator 114 is a shortest distance D4 from the top-most edge of the interior surface 403 of the lens 402. This enables heat generated by the heat generator 440 to follow, in part, a path 440 to the upper corner of the lens 402 and then disperse downward to other portions of the lens 402, thereby maximizing application of the generated heat onto the lens 402 itself while at the same time dispersing the generated heat across a large portion or the entirety of the interior surface 403 of the lens 402.

When the lightbar 400 is mounted to an upward facing surface of a vehicle, the light emitter 112 and the heat generator 114 project downward from a downward facing surface of the PCB 110. In addition, the light emitter 112 and the heat generator 114 are positioned above and facing the reflector 404. The illustrated heat generator 114 in FIG. 15 can be one of a bank of heat generators as described above. A wall 212 can be positioned between the heat generator 114 and the light emitter 112 of FIG. 15 in the manner described above. Such a wall would be elongate along an axis that is into and out of the page in FIG. 15, and perpendicular to the depicted y-axis. A shortest distance from the

As illustrated, the various embodiments described herein can include a system memory. The memory can provide non-volatile, non-transitory storage for the device. The memory can store instructions that are executed by the controller to perform one or more functions or acts, such as those described herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A lighting system, comprising:
a lighting device, the lighting device including:
a housing defining an interior volume of the housing; and
a printed circuit board (PCB) positioned within the interior volume of the housing, the PCB including a substrate, a light emitter mounted to the substrate, and a heat generator configured differently from the light emitter and also mounted to the substrate; and
at least one controller operatively coupled to the light emitter and to the heat generator via the substrate, the at least one controller being configured to control light emission by the light emitter and heat generation by the heat generator.

2. The lighting system of claim 1, wherein the heat generator is positioned closer than the light emitter to an outer edge of a major surface of the PCB.

3. The lighting system of claim 2, wherein a center of the heat generator is less than 0.25 inches from the outer edge.

4. The lighting system of claim 1,
wherein the at least one controller is configured to generate electronic signals to control the light emitter and the heat generator; and
wherein the lighting system further comprises:
at least one processor; and
non-transitory computer-readable storage having stored thereon instructions which, when executed by the at least one processor, cause the at least one controller to generate the electronic signals.

5. The lighting system of claim 4, wherein the electronic signals are configured to cause the at least one controller to:
in a first instance, supply a first magnitude of electrical current to the heat generator when:
an ambient temperature is sensed to be at or below a threshold temperature; and
electrical current is being supplied to the light emitter; and
in a second instance, supply a second magnitude of electrical current to the heat generator when:
the ambient temperature is sensed to be at or below the threshold temperature; and
zero electrical current is being supplied to the light emitter, the second magnitude of electrical current being greater than the first magnitude of electrical current.

6. The lighting system of claim 5, wherein a first total magnitude of electrical current supplied to the heat generator and the light emitter in the first instance is equal to a second total magnitude of electrical current supplied to the heat generator and the light emitter in the second instance.

7. The lighting system of claim 1,
wherein the light emitter includes a light emitting diode.

8. The lighting system of claim 1, wherein the heat generator includes an electrical resistor.

9. The lighting system of claim 1,
further comprising a temperature sensor operatively coupled to the at least one controller,
wherein the at least one controller is configured to adjust power to the heat generator based on a temperature sensed by the temperature sensor.

10. The lighting system of claim 1, wherein the at least one controller is configured to adjust power to the heat generator based on one or more of:
an ambient temperature;
a level of charge of a battery of a vehicle;
whether electrical current is being supplied to the light emitter; and
whether an engine of the vehicle is running.

11. The lighting system of claim 1, wherein a center of the light emitter is in a range from 1.25 inches to 1.50 inches from a center of the heat generator parallel to a major surface of the PCB.

12. The lighting system of claim 1, further comprising a wall projecting from a major surface of the PCB, the wall being positioned between the light emitter and the heat generator and configured to reflect infrared radiation generated by the heat generator.

13. The lighting system of claim 12, wherein a maximum height of the wall above the major surface of the PCB is greater than a maximum height of the heat generator above the major surface of the PCB.

14. A lightbar for a vehicle, comprising:
a housing defining an interior volume of the housing;
a printed circuit board (PCB) positioned in the interior volume of the housing, the PCB including a substrate, light emitters mounted to the substrate, and heat generators configured differently from the light emitters and also mounted to the substrate; and
a controller operatively coupled to the light emitters and to the heat generators via the substrate, the controller being configured to control light emission by the light emitters and heat generation by the heat generators,
wherein the heat generators are positioned closer than the light emitters to an outer edge of a major surface of the PCB.

15. The lightbar of claim 14,
wherein centers of adjacent ones of the heat generators are in a range from 0.25 inches apart to 0.75 inches apart;
wherein centers of adjacent ones of the heat generators are in a range from 0.4 inches apart to 0.5 inches apart; and
wherein centers of the heat generators are less than 0.25 inches from the outer edge.

16. The lightbar of claim 14,
wherein the light emitters are light emitting diodes (LEDs); and
wherein the heat generators are electrical resistors, the electrical resistors each having a power rating of at least 2 Watts.

17. The lightbar of claim 14, further comprising a wall projecting from the major surface of the PCB, the wall being positioned between the light emitters and the heat generators and configured to reflect infrared radiation generated by the heat generators.

18. The lightbar of claim 14, wherein the controller is configured to adjust power to the heat generators based on one or more of:
an ambient temperature;
a level of charge of a battery of a vehicle;
whether electrical current is being supplied to the light emitters; and
whether an engine of the vehicle is running.

19. The lightbar of claim 14, wherein the housing includes a cover comprising metal, an exterior surface of the cover being coated with a material configured to absorb radiant energy from sunlight to heat the cover.

20. A vehicle, comprising:
a vehicle body; and
the lightbar of claim 14 mounted to the vehicle body.
